(19) United States
(12) Patent Application Publication
(10) Pub. No.: US 2025/0364835 A1
(43) Pub. Date: Nov. 27, 2025

(54) MEDICAL CART POWER CONTROL OF CONNECTED DEVICES

(71) Applicant: Ergotron, Inc, St. Paul, MN (US)

(72) Inventors: Arlow Farrell, Smyrna, TN (US); Cameron Elliott Boone, Franklin, TN (US); Ary Inthaluxay, Murfreesboro, TN (US); Lynn B. Smith, Enterprise, AL (US)

(21) Appl. No.: 19/215,915

(22) Filed: May 22, 2025

Related U.S. Application Data
(60) Provisional application No. 63/651,236, filed on May 23, 2024.

(51) Int. Cl. H02J 13/00; A61G 12/00; B62B 5/00; H02J 3/02

(52) U.S. Cl. CPC H02J 13/00002; A61G 12/008; B62B 5/0096; H02J 3/02; H02J 13/00026; H02J 2310/23; H02J 2310/62

(57) ABSTRACT

Systems and techniques may generally be used to individually and selectively enable or disable a plurality of power channels based on detection of activity (or lack thereof) on a workstation. An example system may include a medical cart battery and a power channel for connecting peripheral devices. The system may incorporate an inertial measurement unit (IMU) sensor interface for monitoring cart functions. The system may include a controller in communication with the sensor interface and battery to determine if connected peripheral devices should be powered off based on IMU sensor data. The controller may generate power control instructions which may be executed by a power switch that enables or disables the power channel accordingly. The system may provide automated power management for peripheral devices based on cart movement and usage conditions detected by the IMU sensor.

### CLAIM OF PRIORITY

This patent application claims the benefit of priority, under 35 U.S.C. Section 119 (e), to Arlow Farrell, U.S. Provisional Patent Application Ser. No. 63/651,236, filed May 23, 2024, which is incorporated herein by reference in its entirety.

### BACKGROUND

It has become more common in settings such as schools and hospitals to use mobile workstations. Workstations (e.g., computer carts, electronic cabinets, medical carts, or the like) can be coupled with peripheral devices to facilitate the use of the peripheral device (e.g., a personal computer (PC), a laptop, a printer, a monitor, or the like). In some examples, these carts can include a power supply that enables peripheral devices to be powered for a period of time without connection to a building power source.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic diagram of elements of a system for individually and selectively controlling a plurality of power channels in a medical cart, according to various examples.

FIG. 2 is a schematic diagram showing a sensor network for individually and selectively controlling a plurality of power channels in a medical cart, according to various examples.

FIG. 3 is a schematic diagram showing a workstation system for individually and selectively enabling or disabling a plurality of power channels based on detection of activity (or lack thereof) on a workstation, according to various examples.

FIG. 4 is a circuit board diagram of an alternating current (AC) powered workstation, according to various examples.

FIG. 5 is a circuit board diagram of a direct current (DC) powered workstation, according to various examples.

FIG. 6 is a flowchart illustrating a technique for individually and selectively enabling or disabling a plurality of power channels based on detection of activity (or lack thereof) on a workstation in accordance with various examples.

FIG. 7 is a block diagram illustrating a machine in the example form of a computer system, within which a set or sequence of instructions may be executed to cause the machine to perform any one or more of the techniques discussed herein, according to various examples.

### DETAILED DESCRIPTION

As discussed above, medical carts (or similar carts) can include remote power supplies. In such an instance, one or more peripheral devices connected to a medical cart not in use for a period of time may require that a user manually turns off the peripheral device or may rely on the settings of the peripheral device (e.g., a computer operating system) to turn itself off. However, this can result in higher energy consumption and increase frequency in power supply recharge time.

The inventors have recognized that a peripheral device connected to and powered by a workstation may stop functioning or consume unnecessary energy (e.g., being turned on while not in use). To help address these issues, this disclosure describes a workstation (e.g., a transportable medical cart, a stationary medical cart, or the like) including a selectively power-controlled plurality of power channels, wherein each power channel of the plurality of power channels is configured to connect to a peripheral device (e.g., a monitor, a television, a computing device, a tablet, a barcode scanner, a printer, or the like). Data collected from sensors located on the workstation may be used to control the power output (e.g., alternating current (AC) output, direct current (DC) output, or the like) to peripheral devices.

The systems and techniques disclosed herein may help improve the functionality and usability of a workstation (e.g., medical carts) by selectively rebooting (e.g., turning on, turning off, resetting, or the like) a power channel without having to fully reboot the power of the workstation based on the detection of activity on the workstation or a lack thereof.

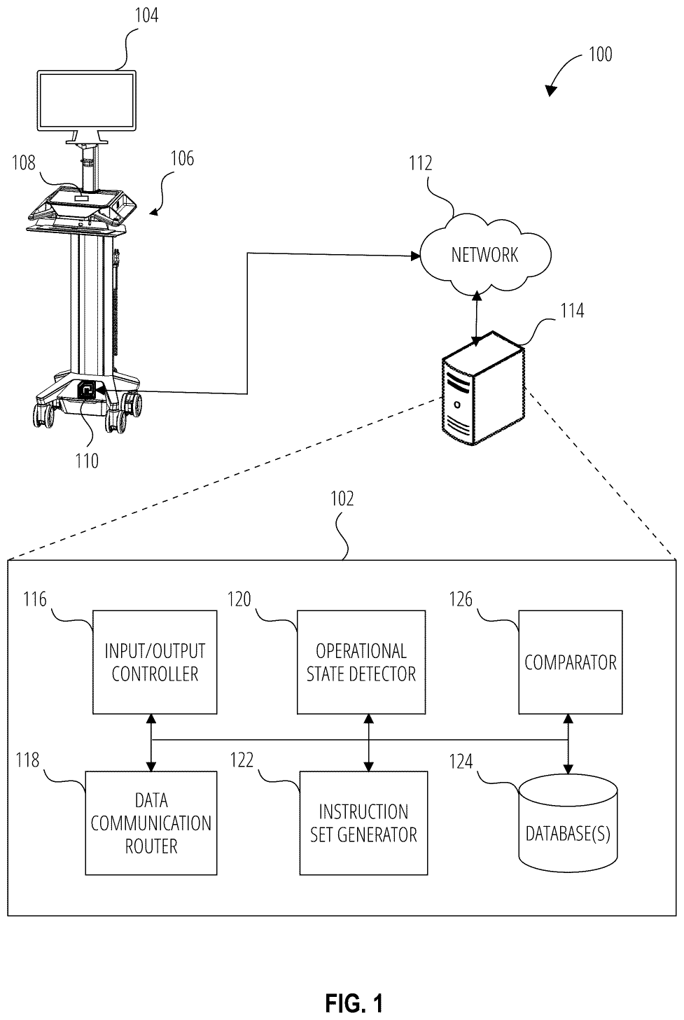

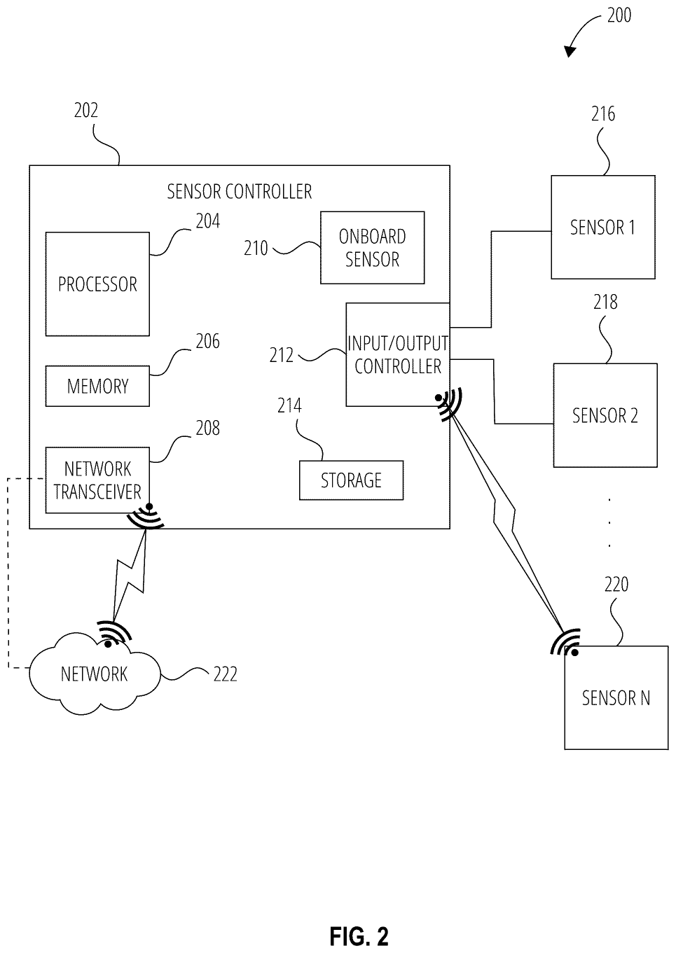

FIG. 1 is a block diagram of an example of an environment 100 and a system 102 for individually controlling a plurality of power channels in a medical cart, according to an embodiment. The environment 100 may include a peripheral device 104 (e.g., a monitor, a printer, a tablet, a bar code scanner, or the like), a workstation 106 (e.g., a transportable medical cart) that includes a variety of sensors 108 (e.g., inertial measurement unit (IMU) sensor, Bluetooth Low Energy (BLE) sensor, foot platter sensor, brake switch sensor, height adjustment sensor, ambient light sensor, air quality sensor, a radioactivity sensor, a radiation sensor, a lighting sensor, a magnetic field sensor, a sit-stand worksurface height sensor, a height adjustment cycle sensor, a vibration sensor, an inertia, a power on/off state sensor, a voltage sensor, a temperature sensor, a current sensor, a battery cycle sensor, a drawer state sensor, a contact sensor, a barometric pressure sensor, a fault status sensor, a wireless networking operational sensor, odometer, decibel meter, oxygen sensor, motion sensor, pressure sensor, ultrasonic sensor, LiDAR, or the like). The sensors 108 may be configured in a sensor array that may be communicatively coupled (e.g., via a sensor network, wired connection, wired network, wireless network, short-wave radio, nearfield communication, or the like) to a sensor controller 110. A more detailed example of a sensor controller is shown in FIG. 2. The workstation 106 may operate in a variety of locations such as, for example, a medical treatment facility.

The sensor controller 110 may collect sensor data from the sensors 108 and may transmit the sensor data to a cloud computing platform via the network 112 (e.g., the internet, cellular network, wired network, wireless network, or the like). The sensor data may be received by a network management server 114 (e.g., a single server, a server cluster, a system on a chip (SoC), a field-programmable gate array (FPGA), an application-specific integrated circuit (ASIC), a cloud computing platform service, or the like) via the network 112. In an example, the network management server 114 may be operating within the cloud computing platform, and the cloud computing platform may facilitate transmission of the sensor data directly to the network management server 114 via the network 112.

The network management server 114 may be communicatively coupled (e.g., via wired network, wireless network, shared bus, or the like) to the system 102. In an example, the system 102 may be a telemetry-based device monitoring engine. The system 102 may include a variety of components such as an input/output controller 116, an operational state detector 120, a comparator 126, an instruction set generator 122, a data communication router 118, and database(s) 124. The components of the system 102 may be implemented in a single computing device (e.g., a server, FPGA, ASIC, SOC, a virtual server, or the like) or may be distributed across multiple computing devices (e.g., a server cluster, a cloud computing platform, a virtual server cluster, or the like).

The input/output controller 116 may obtain a set of sensor data from the sensor array included in the workstation 106. In an example, the set of sensor data may be collected from the sensor array by the sensor controller 110 of the workstation 106. The workstation 106 may then transmit the set of sensor data to the cloud service platform of a cloud computing platform. The input/output controller 116 may obtain the set of sensor data from the cloud service platform. The input/output controller 116 may process (e.g., format, normalize, translate, or the like) the sensor data for use as input by other components in the system 102.

By way of example, and not limitation, the set of sensor data may include sensor readings from an ambient light sensor, air quality sensor, a radioactivity sensor, a radiation sensor, a lighting sensor, a magnetic field sensor, a sit-stand worksurface height sensor, a height adjustment cycle sensor, a vibration sensor, an inertia, a power on/off state sensor, a voltage sensor, a temperature sensor, a current sensor, a battery cycle sensor, a drawer state sensor, a contact sensor, a barometric pressure sensor, a fault status sensor, a wireless networking operational sensor, odometer, decibel meter, oxygen sensor, motion sensor, pressure sensor, ultrasonic sensor, or the like. In an example, the voltage sensor may observe the voltage level of the input power and the internal power of the workstation 106. In another example, the ambient light sensor may observe the ambient light of an environment where the workstation 106 is operation. In another example, the height adjustment cycle sensor may observe a number of times a lift mechanism or corresponding motor have been activated. In another example, an IMU sensor may detect a lack of vibration detection. The foregoing examples represent nonlimiting examples of sensor data that may be included in the set of sensor data. It will be readily understood that the set of sensor data may include a variety of sensor data in varying combinations. The set of sensor data may be stored in the database(s) 124.

The operational state detector 120 may work in conjunction with the comparator 126 to determine an operational state of a peripheral device connected to a power channel of the workstation 106 based on an evaluation of the set of sensor data. In an example, the sensor array may include an IMU sensor (e.g., lift mechanism sensor, vibration sensor, or the like). In various examples, the evaluation of the set of sensor data may include a detection of a lack of vibration of the workstation 106 during a period of time (e.g., a threshold time defined by a user in a software, or the like) observed by the IMU sensor. Upon a determination that there is a lack of vibration of the workstation 106 above the threshold time, for example, the operational state of the workstation 106 may be determined to be idle (e.g., a power channel should be turned off, or the like). In another example, the evaluation of the set of sensor data may include a detection of the adjustment of height of the workstation 106 (e.g., the workstation 106 being lifted, or the like). Upon the determination that there is an activity in the workstation 106 (e.g., lifting the workstation 106, or the like), the operational state of the workstation 106 may be determined to be active (e.g., a power channel should be turned on, or the like).

In an example, the operational state detector 120 may work in conjunction with the comparator 126 to predict an operational state of the workstation 106 based on the evaluation of the set of sensor data. In an example, the evaluation may include a comparison of the set of sensor data to a predictive operation model for the workstation 106. For example, a machine learning model or other predictive model may be generated (e.g., trained, or the like) using training data to determine sets of sensor data that may indicate the future operational state of the workstation 106. The set of sensor data may be provided as inputs to the predictive model which may then generate inputs including a likelihood of the operational state of the workstation 106 being active (or inactive) and a predicted time before the operational state changes. The predictive models may be stored in the database(s) 124.

The instruction set generator 122 may generate a set of instructions based on the operational state of the workstation 106. The data communication router 118 may determine a recipient computing device to receive the set of instructions based on a device identifier of the workstation 106 and a task associated with the set of instructions. The input/output controller 116 may transmit the set of instructions to the recipient computing device. In an example, the input/output controller 116 may format or otherwise modify the outputs for delivery to a particular recipient computing device. For example, the set of instructions may be translated into a script file, executable file, or the like, based on the input requirements of the recipient computing device.

In an example, the task may be to control the power supply of the peripheral device 104, and the set of instructions may include instructions to turn off the power supply to a power channel of a plurality of power channels of the workstation 106 and the power channel may be connected to the peripheral device 104. In another example, the task may be to control the power supply of a second peripheral device (e.g., a printer, a PC, or the like), and the set of instructions may include instructions to turn on the power supply to a second power channel of a plurality of power channels of the workstation 106 and the second power channel may be connected to the second peripheral device.

Automated remote detection of the operational status of the workstation 106 and the instruction delivery may reduce the energy consumption of the workstation 106 by individually turning off power channels connected to peripheral devices not in use and enhance the functionality and usability of the workstation 106 (e.g., medical cart, or the like) by turning on peripheral devices when detecting activity on (or inactivity of) the workstation 106.

FIG. 2 is a block diagram of an example of a sensor network 200 for individually controlling a plurality of power channels in a medical cart, according to an embodiment. The sensor network 200 may provide features as described in FIG. 1 and may be connected to one or more of the management server 114 and the network 112.

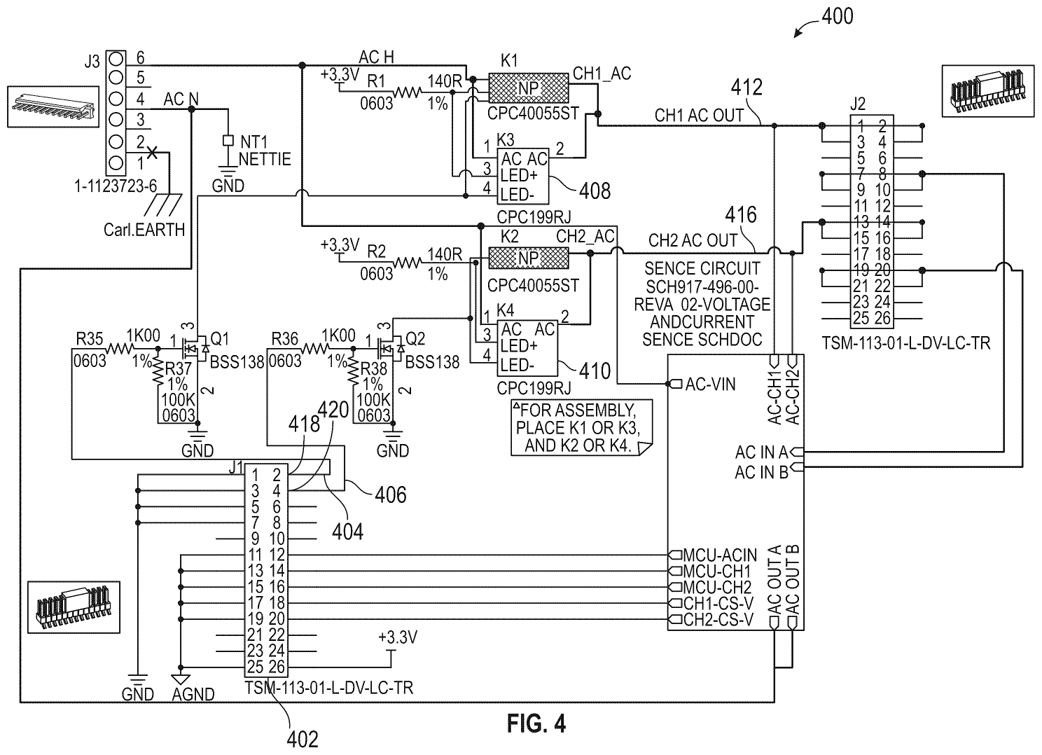

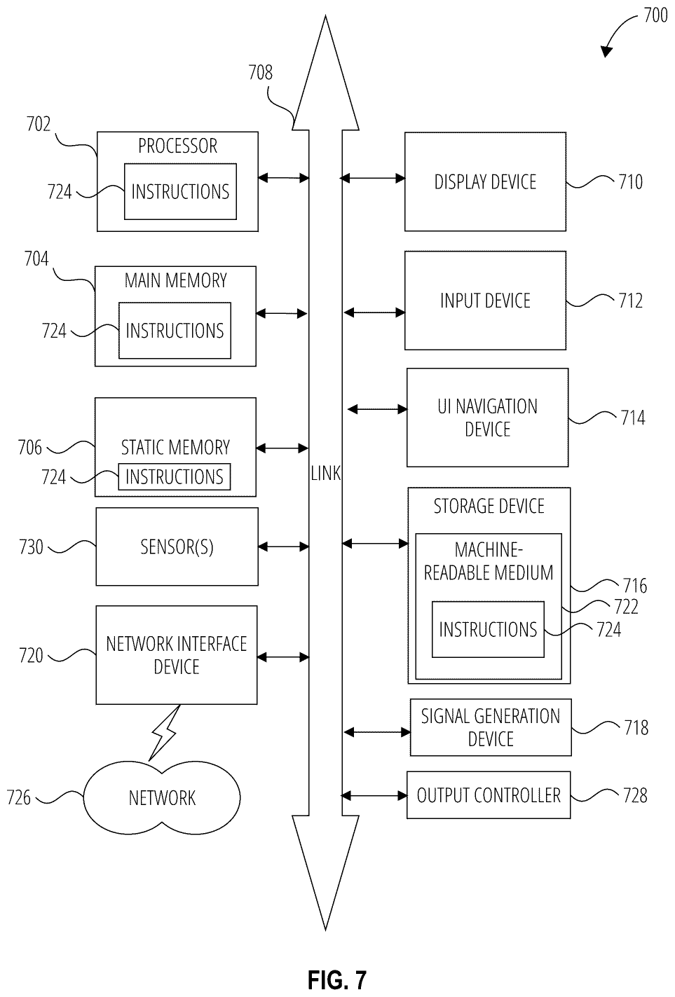

The sensor network 200 may include a sensor controller 202. The sensor controller 202 may include a variety of components including a processor 204 (e.g., processor 702 as described in FIG. 7, or the like), memory 206 (e.g., main memory 704, static memory 706, as described in FIG. 4, or the like), a network transceiver 208, storage 214 (e.g., storage device 716, as described in FIG. 4, or the like), an onboard sensor 210 (e.g., embedded physical sensor, embedded logical sensor, or the like), and an input/output controller 212 (e.g., input device 712, output controller 728 as described in FIG. 4, or the like).

The sensor network 200 may include a sensor array that may include the onboard sensor 210, a first sensor 216, a second sensor 218, and additional n sensors 220. The sensors may be communicatively coupled (e.g., via wired network, wireless network, shared bus, cellular network, short-wave radio, or the like) to the sensor controller 202 via the input/output controller 212.

The memory 206 may include instructions for causing the processor 204 to collect sensor data (e.g., sensor readings, or the like) from the sensors of the sensor array and may store the sensor data in storage 214. The network transceiver 208 may transmit the sensor data to a cloud service platform via the network 222. The network transceiver 208 may communicate with the network 222 via wired network, wireless network, cellular network, short-wave radio, or the like. In an example, the network transceiver 208 may use MQTT and a publish-subscribe model to reduce network utilization and power consumption.

The network transceiver 208 may receive instructions from the cloud service platform which may be placed in the storage 214 and memory 206. When executed, the instructions may cause the processor 204 to perform operations to adjust (e.g., via the input/output controller 212, or the like) an operating parameter of an electronic device that includes the sensor controller 202. For example, ambient light sensor data may be transmitted to the cloud service platform, and instructions may be received the adjust a lighting device of the electronic device upon receipt of a signal from an external device. For example, a signal may be received from a smart lighting switch in a hospital room, and upon receipt of a signal indicating the ambient lighting of the hospital room has been lowered, instructions to turn off a power channel of the electronic device (e.g., workstation 106 shown in FIG. 1) may be triggered. In another example, the instructions may be to turn on the power channel when detecting that the ambient lighting of the hospital has been increased.

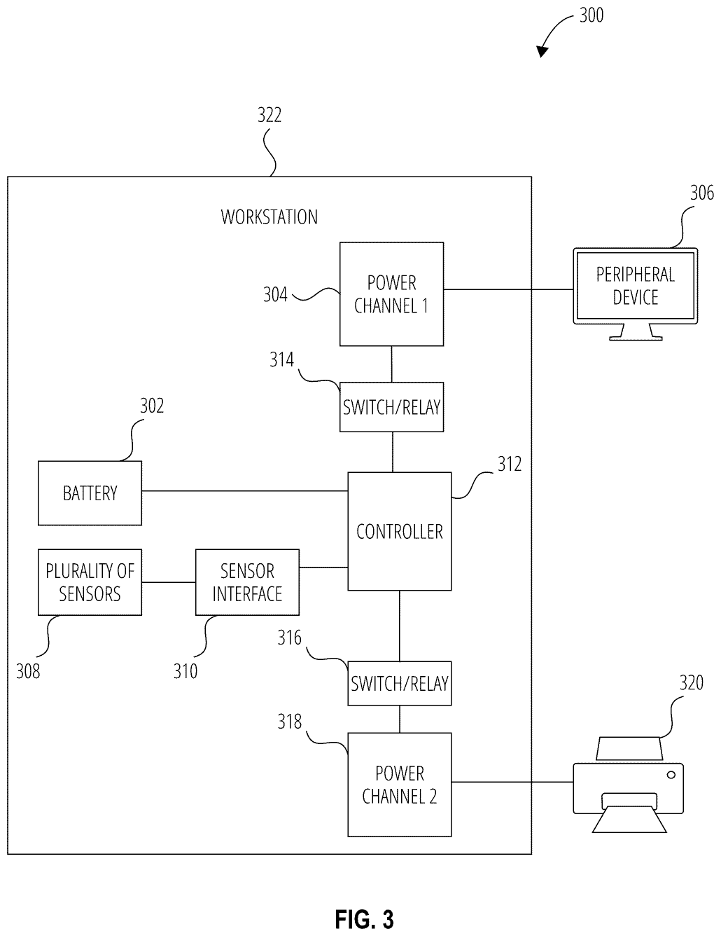

FIG. 3 is a block diagram of an example of a workstation system 300 for individually and selectively enabling or disabling a plurality of power channels based on detection of activity (or lack thereof) on a workstation 322 (which can be or can include the workstation 106). In various examples, each power channel of the plurality of power channels may be configured to connect to a peripheral device (e.g., a monitor, a printer, a computing device, a barcode reader, or the like).

In an example, the workstation 322 (e.g., a transportable medical cart, a stationary medical cart, AC powered medical cart, DC powered medical cart, or the like) may include a battery 302 (e.g., a medical cart battery), a plurality of sensors 308, a sensor interface 310, a controller 312, a power channel 304 connected to a switch 314 (or relay) and a power channel 318 connected to a switch 316 (or relay). In various examples, the workstation 322 may selectively turn on or off the power channel 304 and power channel 318 based on observations of plurality of sensors 308. The plurality of sensors 308 may be configured to observe one or more activities of the workstation 322.

The plurality of sensors 308 may include an inertial measurement unit (IMU), a global positioning system (GPS) sensor, compass, accelerometer, infrared (IR), near field communication (NFC), Bluetooth Low Energy (BLE) sensor, foot platter sensor, brake switch sensor, ambient light sensor, air quality sensor, a radioactivity sensor, a radiation sensor, a lighting sensor, a magnetic field sensor, a sit-stand worksurface height sensor, a height adjustment cycle sensor, a vibration sensor, an inertia sensor, a power on/off state sensor, a voltage sensor, a temperature sensor, a current sensor, a battery cycle sensor, a drawer state sensor, a contact sensor, a barometric pressure sensor, a fault status sensor, a wireless networking operational sensor, odometer, decibel meter, oxygen sensor, motion sensor, pressure sensor, ultrasonic sensor, moisture sensor, or the like

In various examples, the plurality of sensors 308 monitor one or more activities related to the workstation 322. In various examples, the workstation 322 selectively turns off a power channel (e.g., power channel 304, power channel 318, or the like) based on a sensor (or a combination of sensors) of the plurality of sensors 308 (e.g., an IMU sensor, or the like) detecting inactivity on the workstation 322 (e.g., a lack of vibration on the workstation 322, a decrease on the ambiance light, a lack of activity on the power channel, or the like) for a period of time (e.g., a default time, a time threshold defined by a user, or the like). Each power channel of the plurality of power channels may have different settings (e.g., a user may define different timeouts for each power channel, which sensors to use for controlling each channel, or the like).

In various examples, the workstation 322 may use one sensor or a combination of sensors of the plurality of sensors 308 to control the power supply to a power channel of the plurality of power channels and, consequently, the power supply to a peripheral device connected to the power channel. For example, a user may define that the workstation 322 should not consider ambient light (e.g., detected increase or decrease of ambiance light, detected turning on or off of ambiance light, or the like). In an example, the user may define that the workstation 322 should only consider ambient light. In another example, the user may define that detection of noise (or lack thereof) should not be used to control a power channel. In various examples, the user may define that a combination of two or more sensors must be used to control a power channel. For example, a user may define that a power channel (e.g., power channel 304 or power channel 318) may be turned off in case a first sensor detects a lack of vibration and a second sensor detects that the ambient light is turned off for a period of time. In another example, a power channel may be turned on or off based on voice command recognition by an audio sensor.

In various examples, each power channel of the plurality of power channels is configured to connect to a peripheral device (e.g., 306, 320, or the like). In one example, a monitor (e.g., peripheral device 306) is connected to power channel 304. In an example, no activity is detected for a certain period of time on the workstation 322, causing the switch 314 (or relay) to be disabled to turn off the power channel 304 and consequently turn off the peripheral device 306 for power saving (e.g., help reduce depletion of the battery 302 or help reduce energy consumption). In an example, the user can set the amount of time for triggering the turn-off (e.g., the user may set 5 minutes of inactivity, 30 minutes of inactivity, or the like).

In various examples, a sensor of the plurality of sensors 308 may be a proximity sensor (e.g., BLE sensor, NFC, IR, LiDAR, or the like) configured to detect the presence of a person within a certain distance (e.g., a user-adjustable distance, a default distance, or the like) from the workstation 322. In an example, when the proximity sensor detects the presence of a person, a power channel (e.g. power channel 304, power channel 318, or the like) is enabled.

In an example, the controller 312 in communication with the sensor interface 310 determines whether a power channel of the plurality of power channels (e.g., 304, 318, or the like) connected to a peripheral device (e.g., 306, 320, or the like) should be enabled or disabled based on observations of the plurality of sensors 308. The controller 312 generates power control instructions according to the determination of whether the power channel should be powered on or off. In one example, the instructions include instructions to enable (or disable) a switch (e.g., 314, 316, or the like). The switch 314 and the switch 316 may include a metal-oxide-semiconductor field-effect transistor (MOSFET) functioning as a switch, a relay, or the like.

Because the detection of various conditions can be analog or non-binary, the system 102 or the network transceiver 208 may include an algorithm or determination for comparing a determined or detected condition of a person or user to a threshold condition. For example, the system 102 may determine whether a detected or determined proximity exceeds or is below a threshold proximity. The system 102 may then generate an instruction from the instruction set generator 122 when a proximity is greater than the threshold proximity. For example, one or more of the power channels may be disabled when a user proximity exceeds a first threshold (e.g., 10 meters). In another example, one or more of the power channels may be enabled when the user proximity is lower than a second threshold (e.g., 5 meters). The thresholds for enabling and disabling may be the same or may be different depending on a desired powered savings profile or a type of activity expected in a patient room.

This type of control may be applied to various other sensors that are susceptible to noise or non-binary signals such as noise or ambient light. For example, the sound or ambient noise sensor can generate a sound signal that the system 102 can compare to one or more sound pressure thresholds, such as a minimum A-weighted decibels (dBA). The system 102 may, based on a comparison between a detected or determined dBA of the environment and a threshold dBA, enable one or more of the power channels. The system 102 may also consider sharp changes in the sound signal that may be indicative of a user that is not intending to access the workstation 106 or workstation 322. For example, the system 102 may use the sound signal to determine or detect footsteps that may indicate the presence of a user, but that may be determined to be outside a patient room (e.g., based on a combination of the pattern of the signal and the intensity or dBA).

The system 102 may also use multiple signals having thresholds together to determine when to enable or disable one or more power channels of the workstation, such as a proximity signal and threshold and a sound signal and threshold. For example, the system 102 may determine or detect footsteps based on the sound sensor signal that may be above the sound sensor signal threshold, but may determine, based on the proximity signal and threshold, that the footsteps are outside the patient room and therefore the one or more power channels should not be activated. Conversely, the system 102 may determine or detect footsteps based on the sound sensor signal that may be above the sound sensor signal threshold and may determine based on the proximity sensor that the user is located near the workstation 106 or workstation 322 and may therefore enable one or more of the power channels to turn on the peripheral devices. Other sensor signals can also be combined in this way. For example, the sound signal and its comparison to one or more thresholds can be paired with proximity and its one or more thresholds as well as ambient light and its one or more thresholds. The use of various signals and signal thresholds can help to reduce an instance of undesired enabling or disabling of the one or more power channels and can further help to increase power savings.

These various signals can also be weighted by the system based on a predetermined weighting system or based on a learned weighting system of the environment and feedback of user interfacing with the peripheral devices following enabling or disabling by the system 102. For example, noise may have a weight of 1, light may have a weight of 2, and proximity may have a weight of 3 where the system 102 can consider the weight of each signal in making a determination to enable or disable one or more of the power channels. The weights of the signals can also be adjusted or changed. That is the weighting can be dynamic throughout the day or other time period. For example, ambient light may receive a low weighting (e.g., a weighting of 1) during the day and may receive a high weight (e.g., 3) during the night while noise, sound, proximity, or the like may have a weight of 2 at all times.

FIG. 4 illustrates an example of a circuit diagram 400 for an AC-powered workstation (e.g., a medical cart, or the like) including a DC-AC controller inverter 402. In various examples, an AC output of the DC-AC controller inverter is split into parallel lines (e.g., 404 and 406), each line including a controllable relay (e.g., relay 408 and relay 410).

In various examples, in order to selectively turn off a power channel of the AC-powered workstation (e.g., 412 and 416), the controllable relay of the power channel is disabled (e.g., the controllable relay 408 is disabled to turn off the power channel 412, the controllable relay 410 is disabled to turn off the power channel 416, or the like). In an example, the AC power channels 412 and 416 are selectively turned on and off by enabling and disabling the relays 408 and 410, respectively. In an example, relays 608 and 610 are controlled by the enable signals coming out of pins 618 and 620, respectively.

In various examples, a workstation (e.g., medical cart) may selectively disable a power channel by setting a pin (e.g., pins 418 and 420, or the like) to turn on and off using software, where a zero corresponds to off (or false value) and any other number corresponds to a user-definable timer (e.g., a time after which the power channel will be turned off).

In another example, a power channel (e.g., 412 and 416) may be selectively disabled by controlling the voltage of the power channel (e.g., the voltage may be turned to zero to turn off the power channel, or the like).

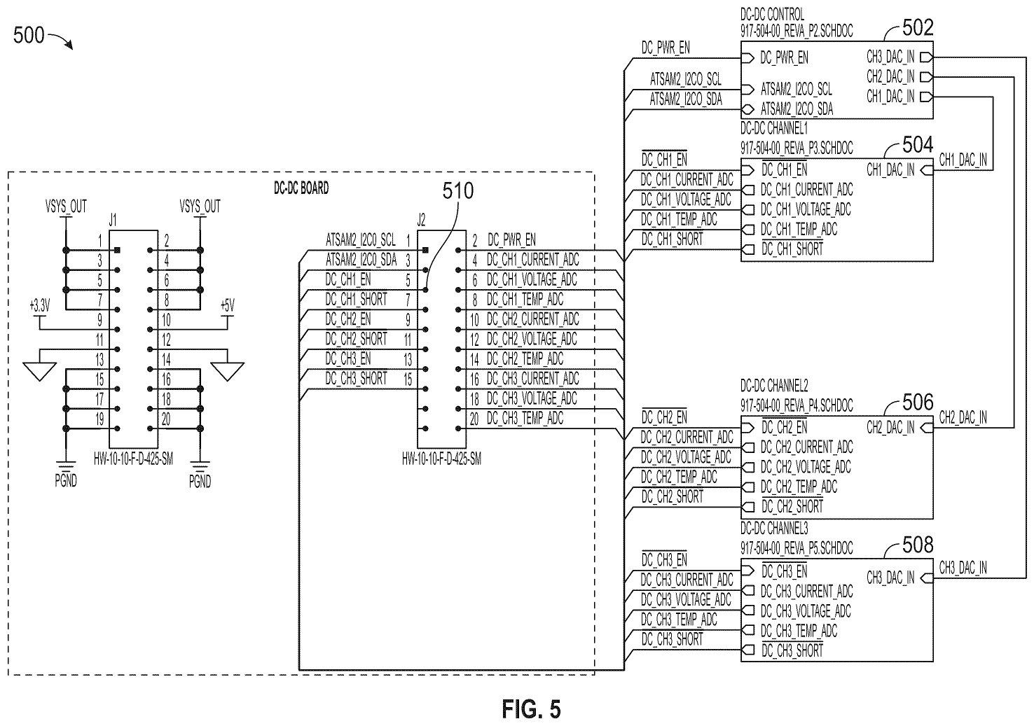

FIG. 5 illustrates an example of a circuit diagram 500 for a DC-powered workstation (e.g., a medical cart, or the like) including a DC-DC controller 502, a power channel 504, a power channel 506, and a power channel 508.

In an example, in order to selectively turn off a power channel, a DC-to-DC converter may be turned off by disabling an enable pin on the converter chip from the processor. For example, for turning off the power channel 504, an enable pin 510 may be disabled.

In another example, a power channel is selectively disabled by turning off a switch (e.g., metal-oxide-semiconductor field-effect transistor (MOSFET) as a switch, or the like) located between the DC output of the DC-to-DC converter and the “connection point” (e.g., power pin), while the DC-to-DC converter remains enabled.

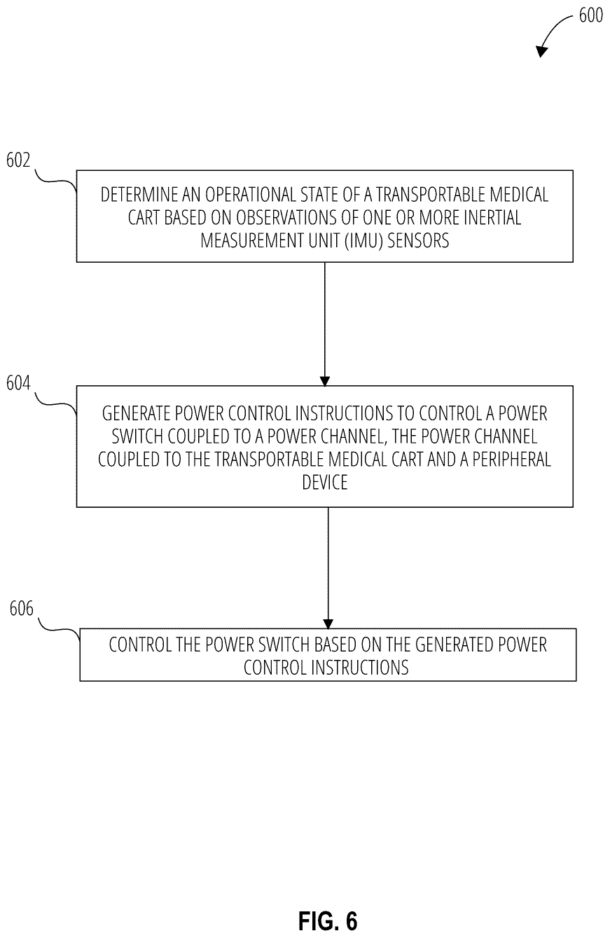

FIG. 6 is a flowchart illustrating a technique 600, according to various examples. In an example, operations of the technique 600 may be performed by processing circuitry, for example, by executing instructions stored in memory. The processing circuitry may include a processor, a system on a chip, or other circuitry (e.g., wiring). For example, the technique 600 may be performed by processing circuitry of a device (or one or more hardware or software components thereof), such as those illustrated and described with reference to FIG. 7.

The technique 600 includes operation 602 to determine an operational state of a transportable medical cart based on observations of one or more IMU sensors. In an example, a controller (e.g., controller 312 shown in FIG. 3) in communication with a sensor interface may determine whether a first power channel of the plurality of power channels connected to the peripheral device should be powered off based on the observations of the one or more IMU sensors and generate power control instructions according to the determination. In an example, the controller may transmit an enable signal to the first power switch based on the observations of one or more sensors.

In various examples, the one or more IMU sensors may observe a push of a button on the transportable medical cart, a change in ambiance light, noise detection, vibration of the transportable medical cart, proximity of a person, or a touch on a touch screen of the transportable medical cart. In an example, the one or more IMU sensors may include a micro-electromechanical systems (MEMS) sensor.

In an example, the transportable medical cart may be an AC powered transportable medical cart including a AC inverter and one controllable relay of a plurality of controllable relays at each power channel of the plurality of power channels. In another example, the transportable medical cart may be a DC powered transportable medical cart including a DC to DC converter and one switch of a plurality of switches at each power channel of the plurality of power channels.

The technique 600 includes operation 604 to, in response to the determination, generate power control instructions to control a power switch coupled to a power channel of a plurality of power channels, the power channel coupled to the transportable medical cart and a peripheral device.

In an example, the control instructions include instructions to disable a converter. In another example, the control instructions may include instructions to disable one or more controllable relays, each controllable relay connected to a power channel. In an example, the control instructions may include instructions to control a first electronic switch, the electronic switch coupled to a first power channel.

In various examples, the peripheral device may include a monitor, a printer, a card reader, a computing device, a barcode reader, or the like.

The technique 600 includes operation 606 to control the power switch based on the generated power control instructions.

FIG. 7 is a block diagram illustrating a machine in the example form of machine 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example machine 700 includes at least one processor 702 (e.g., a central processing unit (CPU), a graphics processing unit (GPU) or both, processor cores, compute nodes, or the like), a main memory 704, and a static memory 706, which communicate with each other via a link 708 (e.g., bus). The machine 700 may further include a display device 710, an input device 712 (e.g., a keyboard), and a user interface UI navigation device 714 (e.g., a mouse). In one embodiment, the display device 710, input device 712, and UI navigation device 714 are incorporated into a single device housing such as a touch screen display. The machine 700 may additionally include a storage device 716 (e.g., a drive unit), a signal generation device 718 (e.g., a speaker), a network interface device 720, and one or more sensors 730, such as an inertial measurement unit (IMU), a global positioning system (GPS) sensor, compass, accelerometer, or other sensors. The machine 700 may include an output controller 728, such as a serial (e.g., universal serial bus (USB), parallel, or other wired or wireless (e.g., infrared (IR), near field communication (NFC), or the like) connection to communicate or control one or more peripheral devices (e.g., a monitor, a printer, a card reader, a computing device, a barcode reader, or the like).

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, the static memory 706, and/or within the processor 702 during execution thereof by the machine 700, with the main memory 704, the static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 722 that excluded transitory signals.

The instructions 724 may further be transmitted or received over a communications network 726 using a transmission medium via the network interface device 720 utilizing any one of a number of well-known transfer protocols (e.g., frame relay, internee protocol (IP), transmission control protocol (TCP), user datagram protocol (UDP), hypertext transfer protocol (HTTP), or the like). Examples of communication networks include a Local Area Network (LAN), a Wide Area Network (WAN), the Internet, mobile telephone networks, and wireless data networks (e.g., Wi-Fi, 3G, and 4G LTE/LTE-A or WiMAX networks, or the like). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a transportable medical cart system comprising: a medical cart battery; a plurality of power channels, each power channel of the plurality of power channels configured to connect to a peripheral device of one or more peripheral devices; a sensor interface configured for coupling with one or more inertial measurement unit (IMU) sensors, the one or more IMU sensors configured to monitor one or more functions of the transportable medical cart; a controller in communication with the sensor interface and coupled to the medical cart battery, the controller is configured to: determine whether a first power channel of the plurality of power channels connected to the peripheral device should be powered off based on observations of the one or more IMU sensors; and generate power control instructions according to the determination; and a power switch connected to the first power channel and in communication with the controller, the power switch configured to enable and disable the first power channel based on the generated power control instructions.

In Example 2, the subject matter of Example 1 includes, wherein the controller is further configured to: determine whether the first power channel of the plurality of power channels connected to the peripheral device should be powered on, the determination based on the observations of the one or more IMU sensors; and generate power control instructions according to the determination.

In Example 3, the subject matter of Example 2 includes, wherein the one or more IMU sensors are configured to monitor at least one of a push of a button of the medical cart, a noise detection, or a touch on a touch screen display of the medical cart.

In Example 4, the subject matter of Examples 1-3 includes, wherein each power channel of the plurality of power channels is an alternating current (AC) output including a controllable relay.

In Example 5, the subject matter of Example 4 includes, wherein each power channel of the plurality of power channels is a direct current (DC) output.

In Example 6, the subject matter of Example 5 includes, wherein the power control instructions include instructions to disable a converter, the converter coupled to the first power channel.

In Example 7, the subject matter of Examples 1-6 includes, wherein the power control instructions include instructions to control an electronic switch, the electronic switch coupled to the first power channel.

In Example 8, the subject matter of Examples 1-7 includes, wherein the IMU sensors are configured to monitor at least a lack of vibration detection.

In Example 9, the subject matter of Examples 1-8 includes, wherein the one or more IMU sensors include a micro-electromechanical systems (MEMS) sensor.

Example 10 is a transportable medical cart system comprising: a mobile cart including a plurality of wheels and a working surface configured to support one or more peripheral devices; a power supply connected to the mobile cart; a plurality of power channels each connected to the mobile cart and the power supply and configured to deliver power from the power supply to the one or more peripheral devices, the plurality of power channels including a first power channel connectable to a peripheral device of the one or more peripheral devices; a device connected to the mobile cart and configured to generate a signal based on one or more functions of the mobile cart; a plurality of power switches each connected to one of the plurality of power channels, the plurality of power switches including a first power switch connected to the first power channel; a controller connected to the mobile cart, the controller configured to: transmit a disable signal to the first power switch based on the signal.

In Example 11, the subject matter of Example 10 includes, wherein the device is a Bluetooth Low Energy (BLE) transceiver connectable to one or more remote devices.

In Example 12, the subject matter of Example 11 includes, wherein the controller is further configured to: determine a proximity of the one or more remote devices; and transmit the disable signal based on the determined proximity of the one or more remote devices being above a first threshold.

In Example 13, the subject matter of Example 12 includes, wherein the controller is further configured to: transmit an enable signal to the first power switch based on the determined proximity of the one or more remote devices being below the first threshold when the first power switch is disabled.

In Example 14, the subject matter of Examples 10-13 includes, wherein the device is a user interface, the controller configured to determine an idle time of the user interface, and the controller configured to transmit the disable signal based on the determined idle time being above a second threshold.

In Example 15, the subject matter of Example 14 includes, wherein the second threshold is configured by a user.

In Example 16, the subject matter of Examples 14-15 includes, wherein the controller is further configured to detect an activity of the user interface, and wherein the controller is configured to transmit an enable signal to the first power switch based on the detected activity of the user interface.

In Example 17, the subject matter of Examples 10-16 includes, wherein the device is one or more IMU sensors.

In Example 18, the subject matter of Example 17 includes, wherein the one or more IMU sensors are configured to generate the signal based on at least one of a push of a button of the medical cart, a noise detection, or a touch on a touch screen display of the medical cart.

In Example 19, the subject matter of Examples 17-18 includes, wherein the one or more IMU sensors are configured to generate the signal based on a lack of vibration detection.

In Example 20, the subject matter of Examples 17-19 includes, wherein the one or more IMU sensors include a micro-electromechanical systems (MEMS) sensor.

In Example 21, the subject matter of Examples 10-20 includes, wherein the controller is further configured to disable a converter based on the signal, the converter coupled to the first power channel.

In Example 22, the subject matter of Examples 10-21 includes, wherein each power channel of the plurality of power channels is an alternating current (AC) output including a controllable relay.

In Example 23, the subject matter of Examples 10-22 includes, wherein each power channel of the plurality of power channels is a direct current (DC) output.

Example 24 is a method comprising: determining an operational state of a transportable medical cart based on observations of one or more inertial measurement unit (IMU) sensors; in response to the determining, generating power control instructions to control a power switch coupled to a power channel of a plurality of power channels, the power channel coupled to the transportable medical cart and a peripheral device; and controlling the power switch based on the generated power control instructions.

Example 25 is a transportable medical cart system comprising: a medical cart battery; a power channel configured to connect to a peripheral device; a sensor interface configured for coupling with an inertial measurement unit (IMU) sensor configured to monitor a function of a transportable medical cart; a controller in communication with the sensor interface and coupled to the medical cart battery, the controller is configured to: determine whether the power channel connected to the peripheral device should be powered off based on observations of the IMU sensor; and generate power control instructions according to the determination; and a power switch connected to the power channel and in communication with the controller, the power switch configured to enable and disable the power channel based on the generated power control instructions.

In Example 26, the subject matter of Example 25 includes, wherein the controller is further configured to: determine whether the power channel connected to the peripheral device should be powered on, the determination based on the observations of the IMU sensor; and generate a second set of power control instructions according to the determination.

In Example 27, the subject matter of Example 26 includes, wherein the IMU sensor is configured to monitor at least one of a lack of vibration detection, a push of a button of the transportable medical cart, a noise detection, or a touch on a touch screen display of the transportable medical cart.

In Example 28, the subject matter of Examples 25-27 includes, wherein the power channel is at least one of an alternating current (AC) output including a controllable relay or a direct current (DC) output.

In Example 29, the subject matter of Examples 25-28 includes, wherein the power control instructions include instructions to disable a converter, the converter coupled to the power channel.

In Example 30, the subject matter of Examples 25-29 includes, wherein the power control instructions include instructions to control an electronic switch, the electronic switch coupled to the first power channel.

In Example 31, the subject matter of Examples 25-30 includes, wherein the IMU sensor include a micro-electromechanical systems (MEMS) sensor.

Example 32 is at least one machine-readable medium including instructions that, when executed by processing circuitry, cause the processing circuitry to perform operations to implement of any of Examples 1-31.

Example 33 is an apparatus comprising means to implement of any of Examples 1-31.

Example 34 is a system to implement of any of Examples 1-31.

Example 35 is a method to implement of any of Examples 1-31.

The above detailed description includes references to the accompanying drawings as referenced by FIG. number herein, which form a part of the detailed description. In the drawings, which are not necessarily drawn to scale, like numerals may describe similar components in different views. Like numerals having different letter suffixes may represent different instances of similar components. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” or the like, are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A transportable medical cart system comprising:
a medical cart battery;
a power channel configured to connect to a peripheral device;
a sensor interface configured for coupling with an inertial measurement unit (IMU) sensor configured to monitor a function of a transportable medical cart;
a controller in communication with the sensor interface and coupled to the medical cart battery, the controller is configured to:
determine whether the power channel connected to the peripheral device should be powered off based on observations of the IMU sensor; and
generate power control instructions according to the determination; and
a power switch connected to the power channel and in communication with the controller, the power switch configured to enable and disable the power channel based on the generated power control instructions.

2. The transportable medical cart system of claim 1, wherein the controller is further configured to:
determine whether the power channel connected to the peripheral device should be powered on, the determination based on the observations of the IMU sensor; and
generate a second set of power control instructions according to the determination.

3. The transportable medical cart system of claim 2, wherein the IMU sensor is configured to monitor at least one of a lack of vibration detection, a push of a button of the transportable medical cart, a noise detection, or a touch on a touch screen display of the transportable medical cart.

4. The transportable medical cart system of claim 1, wherein the power channel is at least one of an alternating current (AC) output including a controllable relay or a direct current (DC) output.

5. The transportable medical cart system of claim 1, wherein the power control instructions include instructions to disable a converter, the converter coupled to the power channel.

6. The transportable medical cart system of claim 1, wherein the power control instructions include instructions to control an electronic switch, the electronic switch coupled to the power channel.

7. The transportable medical cart system of claim 1, wherein the IMU sensor include a micro-electromechanical systems (MEMS) sensor.

8. A transportable medical cart system comprising:
a mobile cart including a plurality of wheels and a working surface configured to support one or more peripheral devices;
a power supply connected to the mobile cart;
a plurality of power channels each connected to the mobile cart and the power supply and configured to deliver power from the power supply to the one or more peripheral devices, the plurality of power channels including a first power channel connectable to a peripheral device of the one or more peripheral devices;
a device connected to the mobile cart and configured to generate a signal based on one or more functions of the mobile cart;
a plurality of power switches each connected to one of the plurality of power channels, the plurality of power switches including a first power switch connected to the first power channel;
a controller connected to the mobile cart, the controller configured to:
transmit a disable signal to the first power switch based on the signal.

9. The transportable medical cart system of claim 8, wherein the device is a Bluetooth Low Energy (BLE) transceiver connectable to one or more remote devices.

10. The transportable medical cart system of claim 9, wherein the controller is further configured to:
determine a proximity of the one or more remote devices; and
transmit the disable signal based on the determined proximity of the one or more remote devices being above a first threshold.

11. The transportable medical cart system of claim 10, wherein the controller is further configured to:
transmit an enable signal to the first power switch based on the determined proximity of the one or more remote devices being below the first threshold when the first power switch is disabled.

12. The transportable medical cart system of claim 8, wherein the device is a user interface, the controller configured to determine an idle time of the user interface, and the controller configured to transmit the disable signal based on the determined idle time being above a second threshold.

13. The transportable medical cart system of claim 12, wherein the second threshold is configured by a user.

14. The transportable medical cart system of claim 12, wherein the controller is further configured to detect an activity of the user interface, and wherein the controller is configured to transmit an enable signal to the first power switch based on the detected activity of the user interface.

15. The transportable medical cart system of claim 8, wherein the device is one or more inertial measurement unit (IMU) sensors.

16. The transportable medical cart system of claim 15, wherein the one or more IMU sensors are configured to generate the signal based on at least one of a push of a button of the mobile cart, a noise detection, or a touch on a touch screen display of the mobile cart.

17. The transportable medical cart system of claim 15, wherein the one or more IMU sensors are configured to generate the signal based on a lack of vibration detection.

18. The transportable medical cart system of claim 16, wherein the one or more IMU sensors include a micro-electromechanical systems (MEMS) sensor.

19. The transportable medical cart system of claim 8, wherein the controller is further configured to disable a converter based on the signal, the converter coupled to the first power channel.

20. The transportable medical cart system of claim 8, wherein each power channel of the plurality of power channels is at least one of an alternating current (AC) output including a controllable relay or a direct current (DC) output.
